(19) United States
(12) Patent Application Publication
(10) Pub. No.: US 2025/0312242 A1
(43) Pub. Date: Oct. 9, 2025

(54) DRUG CRUSHING DEVICE

(71) Applicant: YUYAMA MFG. CO., LTD., Osaka (JP)

(72) Inventors: Naoki KOIKE, Toyonaka-shi (JP); Takanori YOROZU, Toyonaka-shi (JP); Ryosuke FUKAMORI, Toyonaka-shi (JP); Hikaru KATAYAMA, Toyonaka-shi (JP)

(73) Assignee: YUYAMA MFG. CO., LTD., Osaka (JP)

(21) Appl. No.: 19/241,447

(22) Filed: Jun. 18, 2025

Related U.S. Application Data
(63) Continuation of application No. PCT/JP2023/047364, filed on Dec. 29, 2023.

(30) Foreign Application Priority Data
Jan. 20, 2023 (JP) 2023-007189

(51) Int. Cl. A61J 7/00

(52) U.S. Cl. CPC A61J 7/0007

(57) ABSTRACT

A drug crushing device that crushes a solid drug contained in a bag according to one or more embodiments is disclosed, which may include a crushing unit that crushes a drug contained in the bag by applying an external force to the drug; and crush detector that detects if the drug is crushed. In one or more embodiments, the bag may be moved relative to the crushing unit in response to detecting drug crushing by the crushing detector.

### CROSS REFERENCE TO RELATED APPLICATIONS

This application is a continuation application of International Application No. PCT/JP2023/047364 filed on Dec. 29, 2023, which claims priority based on the Article 8 of Patent Cooperation Treaty from prior Japanese Patent Application No. 2023-007189 filed with the Japan Patent Office on Jan. 20, 2023, the entire contents of which are incorporated herein by reference.

### TECHNICAL FIELD

The disclosure relates to a drug crushing device that crushes solid drugs such as tablets into a substantially powder form or a substantially granular form.

### BACKGROUND

Tablets are one of typical forms of drugs, and patients take tablets by swallowing the tablets as they are. However, some patients have difficulty in swallowing tablets. When tablets are prescribed to such patients, pharmacists or the like sometimes grind the tablets with, for example, a mortar and a pestle to form the tablets into powder medicine for the patients to take. Japanese patent application publication No. 2022-188176 is an example of background art.

However, crushing tablets is time-consuming and laborious, and hence an improvement has been desired. A drug crushing device according to one or more embodiments may break solid drugs such as tablets.

### SUMMARY

A drug crushing device that crushes a drug contained in a bag according to one or more embodiments may include a crushing unit that crushes a drug contained in the bag by applying an external force to the drug; and a crush detector that detects if the drug is crushed. In one or more embodiments, the bag may be moved relative to the crushing unit in response to detecting drug crushing by the crushing detector.

A drug crushing device according to one or more embodiments may include the crushing unit and the crushing detector, and may move the bag relative to the crushing unit on condition that the crush detector has confirmed that the drug has been crushed. That is, any one of the bag or the crushing unit is moved on condition that the crush detector has confirmed that the drug has been crushed. Thus, a drug crushing device according to one or more embodiments, work of breaking the drug may be performed even when a worker is not watching.

A drug crushing device according to one or more embodiments may further include feeder for feeding the bag, and that the feeder be configured to feed the bag on condition that the crush detector has confirmed that the drug has been crushed.

A drug crushing device according to one or more embodiments may include the crushing unit, the crushing detector, and the feeder, and the feeder feeds the bag on condition that the crush detector has confirmed that the drug has been crushed. Thus, according to a drug crushing device according to one or more embodiments, work of breaking the drug may be performed even when the worker is not watching.

In one or more embodiments, it may be desired that the crushing unit includes a hammer portion, that strikes against the bag to crush the drug, and that the crush detector be configured to detect a position of the hammer portion in a state of having been swung down onto the drug.

For example, when fragments of a drug after being struck with a hammer are large, the hammer should stop at a high position. When the fragments are small, the hammer should advance to a low position to stop. This aspect focuses on this fact.

Through detection of the position of the hammer in a state of having been swung down onto the drug, a size of the drug after being crushed may be indirectly known, and whether or not the drug has been crushed may be confirmed. It may be desired that the above-mentioned position be a distance from some reference position.

In one or more embodiments, it may be desired that the bag be formed of a drug packaging paper sheet, a plurality of bags be connected to each other in a strip shape, and one edge of the strip shape have a joining edge at which the drug packaging paper sheet is joined, and that the feeder be configured to move the bags connected to each other in a strip shape by holding the joining edge.

The bag to be used in the drug crushing device of this aspect is formed of the drug packaging paper sheet, and the plurality of bags are connected to each other in a strip shape. One edge of the strip shape has the joining edge at which the drug packaging paper sheet is joined. The feeder of the drug crushing device of this aspect moves the bags connected to each other in a strip shape by holding the joining edge. Here, the joining edge is an edge on which the drug is not present, and hence is less uneven when the joining edge is put on a flat surface. In the drug crushing device according to one or more embodiments, the joining edge with less unevenness is held, and hence the bags may be held firmly and may be fed smoothly. Further, no drug is present on the joining edge, and hence such an effect may be expected that the feeding operation is not hindered by the drug.

It may be desired that a drug crushing device according to one or more embodiments may further include vibrator that vibrates the bag after at least crushing operation is performed by the crushing unit.

For example, when a drug is cracked by striking the drug, the cracked fragments are clustered together in one place. Alternatively, when the drug is cracked by striking the drug, and thus is in a semi-cracked state, the semi-cracked fragments are further clustered together in one place. A drug crushing device according to one or more embodiments may include the vibrator, and the bag is vibrated by the vibrator after at least crushing operation is performed by the crushing unit. Thus, the fragments in a clustered state are separated from each other by the vibration. After that, for example, by striking the drug again, the fragments of the drug become finer.

According to a drug crushing device according to one or more embodiments, solid drugs may be broken by a machine, thereby being capable of reducing the workload of pharmacists.

### BRIEF DESCRIPTION OF DRAWINGS

FIG. 1A is a diagram illustrating a perspective view of a drug crushing device with a hammer member raised according to one or more embodiments.

FIG. 1B is a diagram illustrating a perspective view of a drug crushing device with a hammer member swung down according to one or more embodiments.

FIG. 2 is a diagram illustrating a side view of a drug crushing device such as is shown in FIG. 1A and FIG. 1B.

FIG. 3A is a diagram illustrating a perspective view of a crushing unit of a drug crushing device such as is shown in FIG. 1A and FIG. 1B.

FIG. 3B is a diagram illustrating a perspective view of a crushing unit with a placement table and the hammer member (including a drive mechanism) separated from each other.

FIG. 4A is a diagram illustrating a perspective view of a feeder of a drug crushing device of FIG. 1A and FIG. 1B.

FIG. 4B is a diagram illustrating an exploded perspective view of parts that form the feeder.

FIG. 5 is a diagram illustrating a sectional perspective view of a drug packaging bag that has been held by a feeder of a drug crushing device such as is shown in FIG. 1A and FIG. 1B.

FIG. 6A is a diagram illustrating a perspective view of a vibrator of a drug crushing device such as is shown in FIG. 1A and FIG. 1B.

FIG. 6B is a diagram illustrating a sectional view of a vibrator of a drug crushing device such as is shown in FIG. 1A and FIG. 1B.

FIG. 7 is a diagram illustrating a step of forming drug packaging bags.

FIG. 8A, FIG. 8B, FIG. 8C, and FIG. 8D are diagrams sequentially illustrating steps of crushing tablets by the drug crushing device of FIG. 1A and FIG. 1B, a left part of each of FIG. 8A to FIG. 8D showing, for example, a posture of the crushing unit, a right part of each of FIG. 8C and FIG. 8D showing a plan view of the drug packaging bag after each step is completed.

FIG. 9E, FIG. 9F, FIG. 9G, and FIG. 9H are diagrams sequentially illustrating, steps of crushing tablets by the drug crushing device such as is shown in FIG. 1A and FIG. 1B, which follow FIG. 8A to FIG. 8D, a left part of each of FIG. 9E to FIG. 9H showing, for example, a posture of the crushing unit, a right part of each of FIG. 9E to FIG. 9H showing a plan view of the drug packaging bag after each step is completed.

FIG. 10I, FIG. 10J, FIG. 10K, and FIG. 10L are diagrams sequentially illustrating steps of crushing tablets by the drug crushing device such as is shown in FIG. 1A and FIG. 1B, which follow FIG. 9E to FIG. 9H, a left part of each of FIG. 10I to FIG. 10L showing, for example, a posture of the crushing unit, a right part of each of FIG. 10I to FIG. 10L showing a plan view of the drug packaging bag after each step is completed.

FIG. 11M, FIG. 11N, and FIG. 11O are diagrams illustrating sequentially illustrating steps of crushing tablets by the drug crushing device such as is shown in FIG. 1A and FIG. 1B, which follow FIG. 10I to FIG. 10L, a left part of each of FIG. 11M to FIG. 11O showing, for example, a posture of the crushing unit, a right part of each of FIG. 11M to FIG. 11O showing a plan view of the drug packaging bag after each step is completed.

FIG. 12A and FIG. 12B are diagrams illustrating a drug packaging bag that is put on the drug crushing device such as is shown in FIG. 1A and FIG. 1B and tablets in the drug packaging bags are being crushed, FIG. 12A showing a state in which the hammer member has been swung down, FIG. 12B showing a state in which the bags are fed out after crushing is completed.

### DETAILED DESCRIPTION

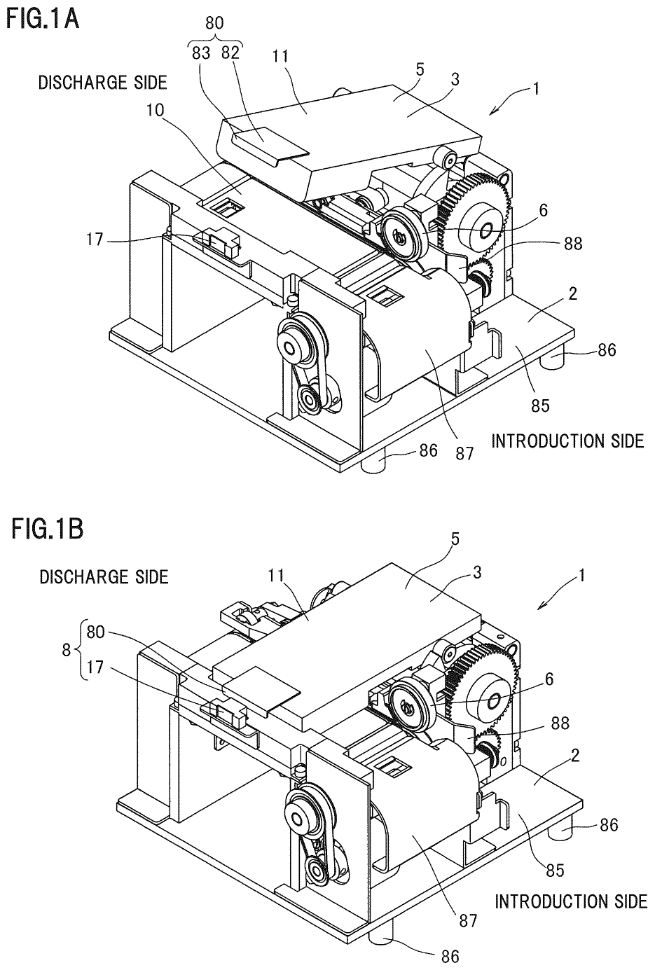

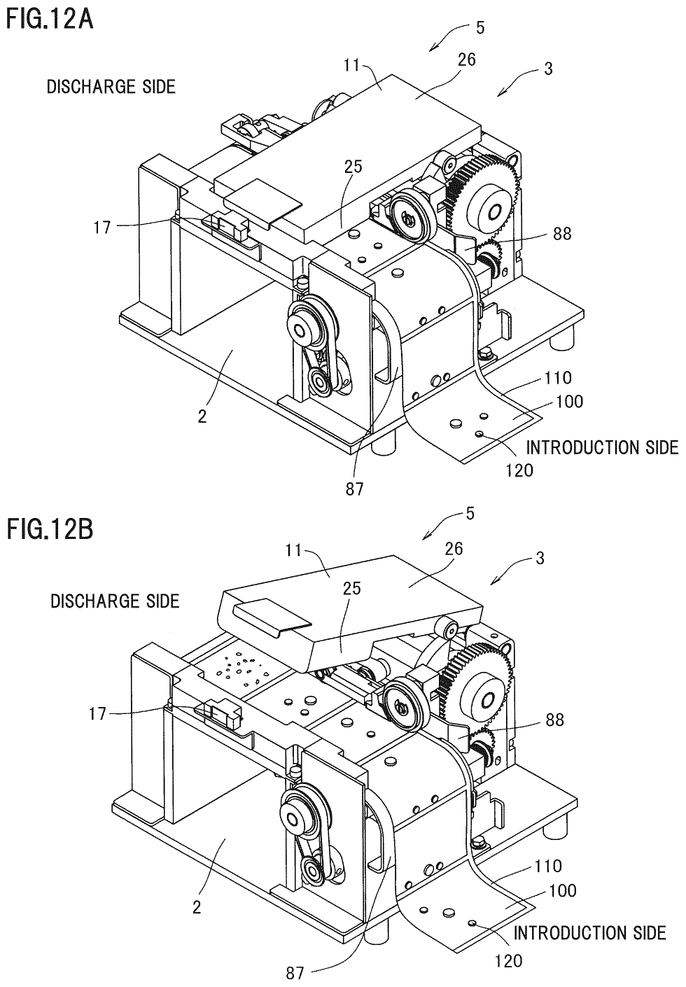

A drug crushing device according to one or more embodiments is described. As illustrated in FIG. 12A and FIG. 12B, a drug crushing device 1 according to one or more embodiments is a device that allows drug packaging bags 100 connected to each other in a strip shape to be put thereon, crushes tablets 120 (drugs) by applying an external force to the drugs contained in the drug packaging bags 100, and feeds the drug packaging bags 100 subjected to crushing, to an outside. In the following description, a side from which the drug packaging bags 100 are introduced is referred to as “introduction side”, and a side to which the drug packaging bags 100 are discharged is referred to as “discharge side”, with a posture illustrated in FIG. 1A, FIG. 1B, FIG. 12A, and FIG. 12B being used as the standard.

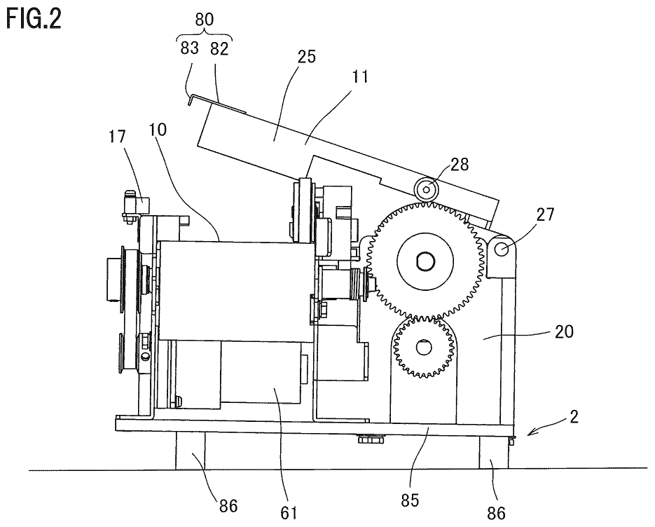

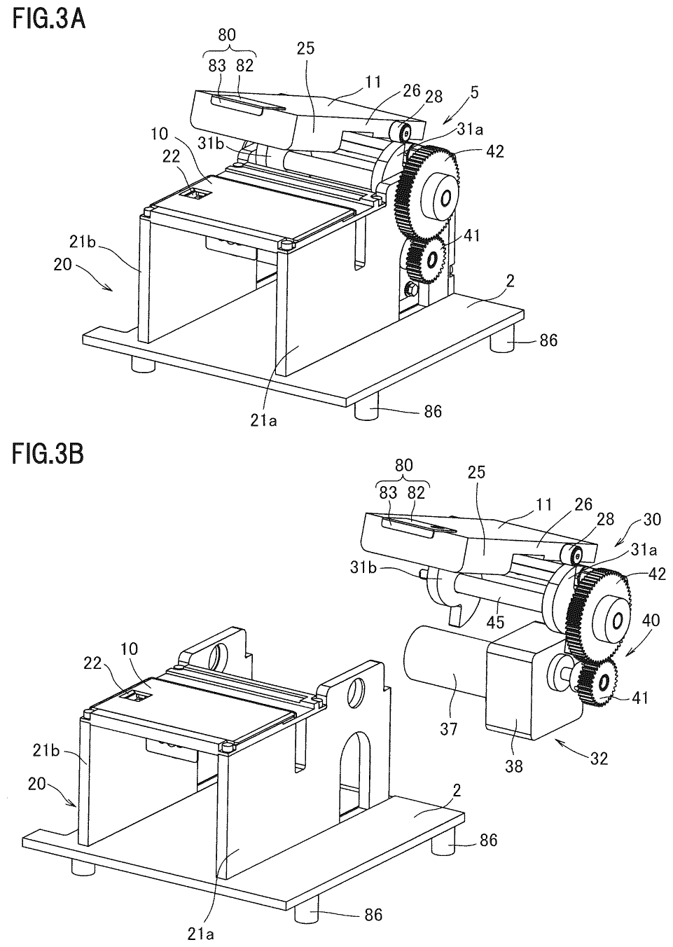

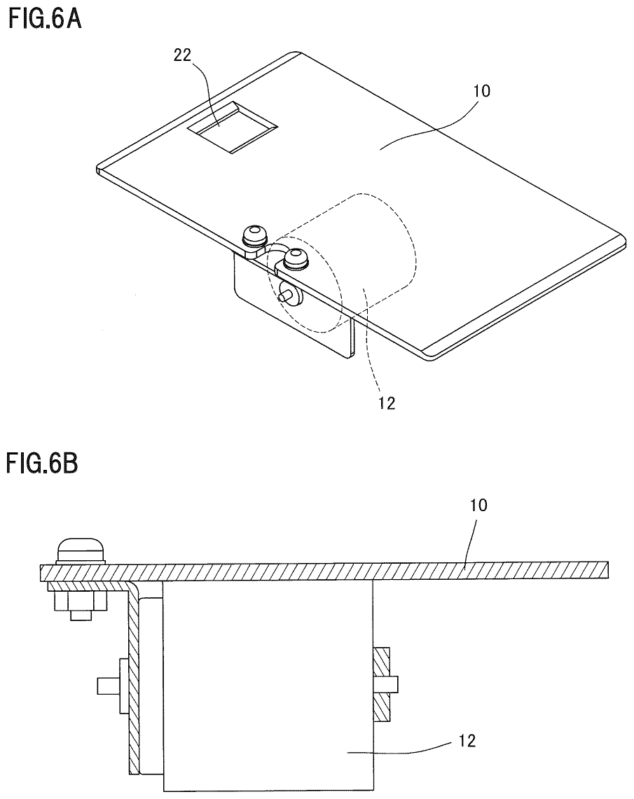

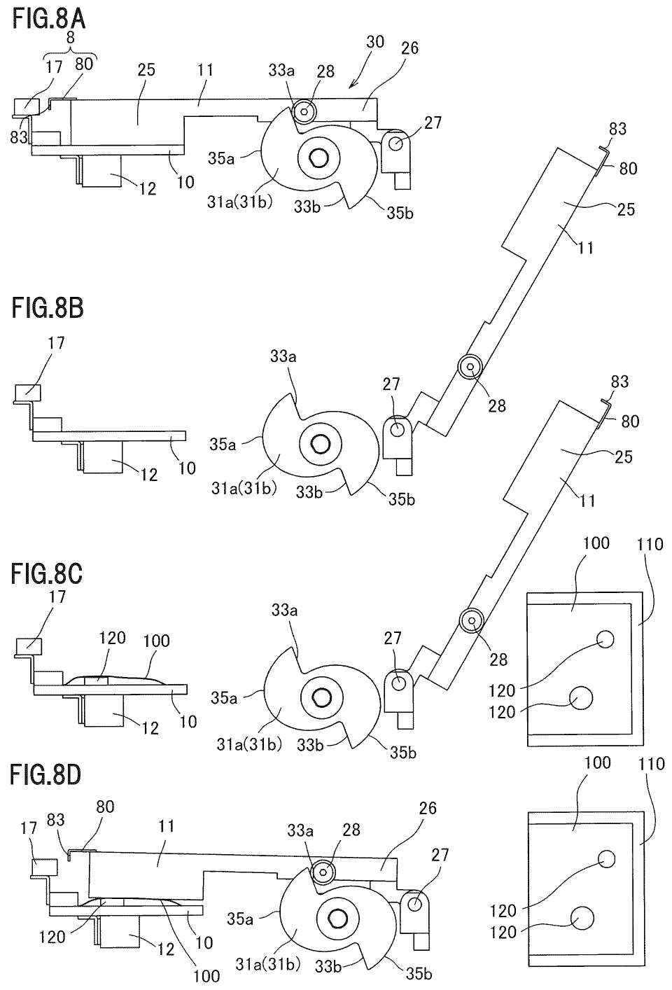

In the drug crushing device 1 according to one or more embodiments, a main device 3 is fixed to a base 2 as illustrated in FIG. 1A, FIG. 1B, FIG. 12A, and FIG. 12B. The main device 3 mainly includes a crushing unit 5 and feeder 6. The crushing unit 5 breaks the tablets 120 (drugs) in the drug packaging bags 100 by striking the drug packaging bags 100. As illustrated in FIG. 1A, FIG. 2, FIG. 3A, FIG. 3B, FIG. 12B, and the like, the crushing unit 5 includes a placement table 10 on which the drug packaging bags 100 are to be placed, and a hammer member (hammer portion) 11. As illustrated in FIG. 6A, FIG. 6B, and FIG. 8A to FIG. 11O, a vibrator 12 is mounted to the placement table 10 as vibrating unit, and the vibrator 12 vibrates the placement table 10.

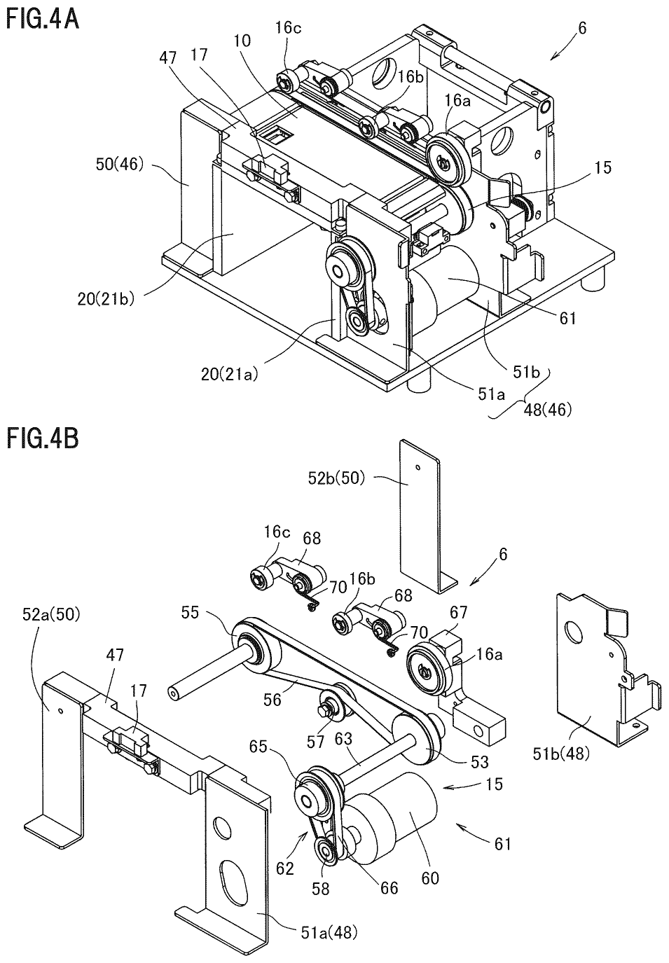

As illustrated in FIG. 4A and FIG. 4B, the feeder 6 includes a drive-side belt mechanism 15 and pressing-side rollers 16a, 16b, and 16c, and holds one edge of the drug packaging bags 100 between the drive-side belt mechanism 15 and the pressing-side rollers 16a, 16b, and 16c. The feeder 6 feeds out the drug packaging bags 100 by causing the drive-side belt mechanism 15 to travel. Further, the drug crushing device 1 according to one or more embodiments includes crush detector 8 that detects whether or not the tablets 120 have been crushed. The crush detector 8 detects a height of the hammer member (hammer portion) 11 in a state of having been swung down onto the drugs, to determine a degree of crushing. As illustrated in FIG. 1A, FIG. 1B, and FIG. 8A to FIG. 11O, the crush detector 8 includes a confirmation sensor 17 and a dog 80. (Crushing Unit)

Each component is described below. As described above, the crushing unit 5 includes the placement table 10 on which the drug packaging bags 100 are to be placed, and the hammer member (hammer portion) 11. As illustrated in FIG. 3A and FIG. 3B, the crushing unit 5 includes a horizontal support member 20 that supports each component, and the placement table 10 and the hammer member 11 are mounted to the horizontal support member 20. The horizontal support member 20 includes vertical walls 21a and 21b opposed to each other as illustrated in FIG. 3A and FIG. 3B.

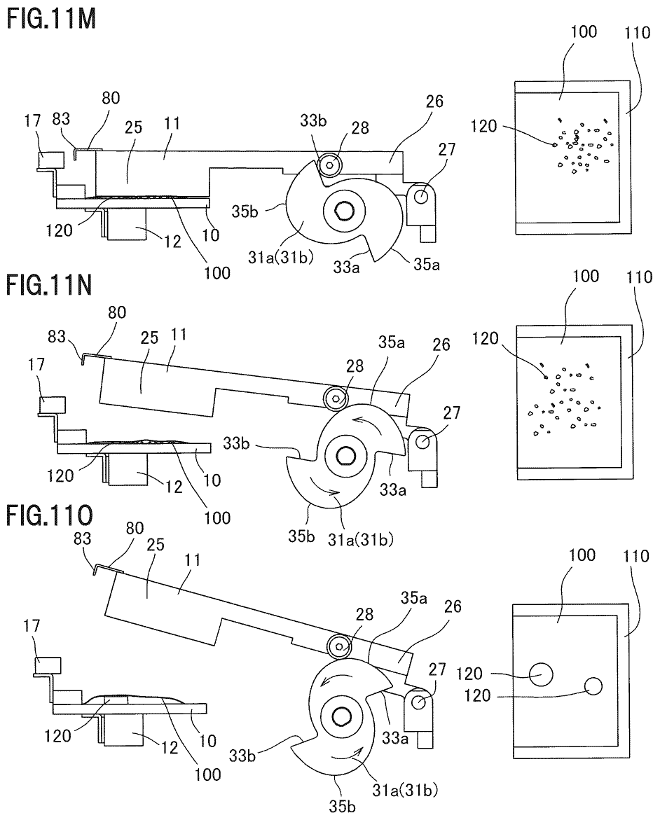

The placement table 10 is a substantially quadrangular metal plate having considerable rigidity. An opening 22 is formed on one end side of the placement table 10. A photoelectric sensor (not shown) is provided below the opening 22. The photoelectric sensor is a sensor that detects whether or not the drug packaging bag 100 is present on the placement table 10. As illustrated in FIG. 6A, FIG. 6B, and FIG. 8A to and FIG. 11O, the vibrator 12 is mounted to a lower portion of the placement table 10. The placement table 10 is fixed on the horizontal support member 20 with a certain degree of freedom, and may vibrate in an up-and-down direction with respect to the placement table 10.

As illustrated in FIG. 2, FIG. 3A, FIG. 3B, and FIG. 8A to FIG. 11O, an entirety of the hammer member 11 is plate-shaped, and a region on its distal end side is made particularly thick. That is, the thicker region at the distal end of the hammer member 11 functions as a striking portion 25, while other thinner plate-shaped region functions as a handle portion 26. The striking portion 25 is a low-height rectangular parallelepiped having considerable rigidity and weight. A planar shape of the striking portion 25 is substantially quadrangular, and is substantially similar in shape to the placement table 10. The planar shape of the striking portion 25 is slightly smaller than that of the placement table 10.

As illustrated in FIG. 2 and FIG. 8A to FIG. 11O, an end portion of the handle portion 26 of the hammer member 11 is supported on the horizontal support member 20 through intermediation of a pin 27. The hammer member 11 is cantilevered and supported at the handle portion 26 in a swingable manner, and may perform a swinging up movement and a swinging down movement. Cam followers 28 are provided on side surfaces of the hammer member 11, respectively, and between the pin 27 and the striking portion 25.

As illustrated in FIG. 1A, FIG. 1B, FIG. 2, FIG. 3A, FIG. 3B, and FIG. 8A to FIG. 11O, the dog 80 is provided at the distal end (free end) of the striking portion 25 and in a center of the striking portion 25 in a width direction. The dog 80 reflects light emitted from the confirmation sensor 17, and is a member to be detected by the photoelectric sensor. The dog 80 is a metal plate bent into an “L” shape, and includes a mounting piece 82 and a detection piece 83. As illustrated in FIG. 1A and FIG. 1B, the dog 80 is mounted to the distal end portion of the hammer member 11 with the mounting piece 82 fixed to an upper surface of the striking portion 25. The detection piece 83 of the dog 80 is located so as to protrude from the free end of the striking portion 25, and hangs down from the upper surface of the striking portion 25.

As described above, the hammer member 11 is cantilevered and swingable, and is raised by a cam mechanism 30 and swung down from a fixed height onto the placement table 10. As illustrated in FIG. 3A and FIG. 3B, the cam mechanism 30 includes cams 31a and 31b, the above-mentioned cam followers 28 of the hammer member 11, and a power transmission mechanism 32 that rotates the cams 31a and 31b. As illustrated in FIG. 8A to FIG. 11O, a contour of each of the cams 31a and 31b has two sets of involute curves connected by two steps 33a and 33b. That is, each of the cams 31a and 31b has two curves 35a and 35b that gradually increase in distance from a center of each cam, and the two steps 33a and 33b.

As illustrated in FIG. 3A and FIG. 3B, the power transmission mechanism 32 includes a motor 37, a reduction gear 38, and a gear train 40. An output shaft (not shown) of the motor 37 is connected to the reduction gear 38. An output shaft of the reduction gear 38 is connected to a small gear 41 of the gear train 40. The small gear 41 is engaged with a large gear 42. The large gear 42 is connected to a cam shaft 45, and the above-mentioned cams 31a and 31b are mounted to the cam shaft 45.

A layout of the power transmission mechanism 32 in one or more embodiments is as illustrated in FIG. 3A and FIG. 3B. The motor 37 and the reduction gear 38 are housed below the cam shaft 45 and in a region surrounded by the vertical walls 21a and 21b of the horizontal support member 20. The gear train 40 is provided outside the vertical walls 21a and 21b of the horizontal support member 20. The cam shaft 45 is rotatably supported by the vertical walls 21a and 21b of the horizontal support member 20, and the two cams 31a and 31b are provided in the region surrounded by the vertical walls 21a and 21b.

A rotational force of the motor 37 is decelerated by the reduction gear 38 and the gear train 40 of the power transmission mechanism 32, and is transmitted to the cam shaft 45, thereby rotating the cams 31a and 31b. As a result, heights of the cam followers 28, which are engaged with the cams 31a and 31b, change, and thus the hammer member 11 swings up and down. That is, when the cams 31a and 31b are rotated under a state in which the cam followers 28 are engaged with the curves 35a and 35b of the cams 31a and 31b, the hammer member 11 swings upward, and the striking portion 25 is raised. When the striking portion 25 reaches its highest point and the cams 31a and 31b are further rotated, the cam followers 28 reach the steps 33a and 33b of the cams 31a and 31b, and the cam followers 28 lose support at once. As a result, gravity causes the hammer member 11 to swing downward, and the striking portion 25 drops.

### (Feeder)

As described above, the feeder 6 includes the drive-side belt mechanism 15 and the pressing-side rollers 16a, 16b, and 16c. Further, a guide portion 47 is attached to the feeder 6. As illustrated in FIG. 4A and FIG. 4B, the feeder 6 includes a vertical support member 46 that supports each component, and each component is mounted to the vertical support member 46. As illustrated in FIG. 4A and FIG. 4B, the vertical support member 46 includes an introduction-side support portion 48 and a discharge-side support portion 50. The introduction-side support portion 48 includes a left-side vertical wall 51a and a right-side vertical wall 51b. Both the left-side vertical wall 51a and the right-side vertical wall 51b extend perpendicularly to the above-mentioned vertical wall 21a of the horizontal support member 20 in plan view. The discharge-side support portion 50 also includes a left-side vertical wall 52a and a right-side vertical wall 52b. Both the left-side vertical wall 52a and the right-side vertical wall 52b extend perpendicularly to the above-mentioned vertical wall 21b of the horizontal support member 20 in plan view.

In the drive-side belt mechanism 15, a feed belt 56 is stretched around a drive-side pulley 53 and a driven-side pulley 55. Further, a tension pulley 57 is held in contact with the feed belt 56. The drive-side pulley 53 is rotated by receiving power transmission from a geared motor 60. That is, a power transmission mechanism 61 of the drive-side belt mechanism 15 includes the geared motor 60, a belt transmission portion 62, and a transmission shaft 63. The belt transmission portion 62 includes a small pulley 58, a large pulley 65, and a transmission belt 66 stretched around both the pulleys. An output shaft of the geared motor 60 is connected to the small pulley 58 of the belt transmission portion 62. The large pulley 65 of the belt transmission portion 62 is connected to the transmission shaft 63.

The pressing-side roller 16a is a roller having a large diameter, and is pressed downward by a push-down member 67. Each of the pressing-side rollers 16b and 16c is a roller having a small diameter, and includes an arm portion 68. A torsion spring 70 is engaged with the arm portion 68, and hence the roller is pressed downward.

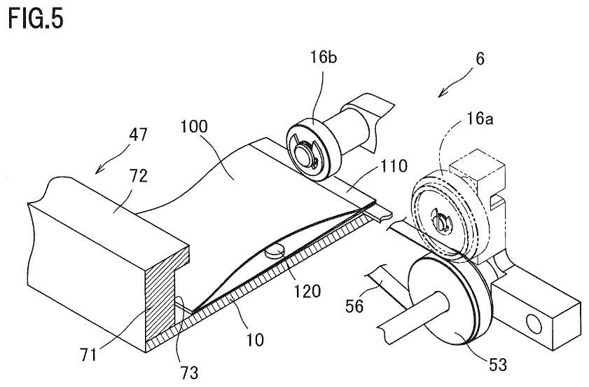

The guide portion 47 is a portion including a vertical wall 71 and an upper wall 72 as illustrated in FIG. 5, and has a groove-shaped portion 73 formed between the walls.

The layout of the feeder 6 in one or more embodiments is illustrated in FIG. 4A, FIG. 4B, and FIG. 5. The drive-side belt mechanism 15 is provided on an edge portion of the placement table 10 closer to the handle portion 26 of the hammer member 11, and the pressing-side rollers 16a, 16b, and 16c are arranged in series on the edge portion. That is, the drive-side pulley 53 and driven-side pulley 55 of the drive-side belt mechanism 15 are arranged so as to be apart from the placement table 10 to front and rear sides, and the feed belt 56 is arranged so as to surround the edge portion of the placement table 10. An upper part of the feed belt 56 travels from the drive-side pulley 53 side toward the driven-side pulley 55 side on the upper side of the placement table 10, and a lower part of the feed belt 56 travels from the driven-side pulley 55 side toward the drive-side pulley 53 side on the lower side of the placement table 10.

The pressing-side rollers 16a, 16b, and 16c are arranged in series directly above the upper side of the feed belt 56. The pressing-side roller 16a is at a position closest to the introduction side, and other pressing-side rollers 16b and 16c are subsequently arranged toward the discharge side.

The power transmission mechanism 61 of the drive-side belt mechanism 15 is provided on the introduction side of the placement table 10, and is supported by the left-side vertical wall 51a and the right-side vertical wall 51b of the introduction-side support portion 48. The geared motor 60 of the power transmission mechanism 61 is housed in a region surrounded by the left-side vertical wall 51a and the right-side vertical wall 51b. The belt transmission portion 62 is provided outside the left-side vertical wall 51a. The transmission shaft 63 is rotatably supported at both ends thereof by the left-side vertical wall 51a and the right-side vertical wall 51b. The drive-side pulley 53 is provided in a region surrounded by and located between the left-side vertical wall 51a and the right-side vertical wall 51b, and near the right-side vertical wall 51b. The driven-side pulley 55 is supported by the discharge-side support portion 50.

As illustrated in FIG. 4A, FIG. 4B, and FIG. 5, the guide portion 47 is provided on an edge of the placement table 10 that is opposed to the edge on which the drive-side belt mechanism 15 is provided.

The positional relationship between the placement table 10 and the feeder 6 is roughly described. The feed belt 56 is arranged along one edge of the placement table 10, and the groove-shaped portion 73 of the guide portion 47 extends along an edge opposed to the one edge of the placement table 10.

### (Confirmation Sensor)

The confirmation sensor 17 is a reflective photoelectric sensor. The confirmation sensor 17 is provided on the guide portion 47. The confirmation sensor 17 detects the height of the hammer member 11 after striking the drug packaging bag 100. When tablets are finely crushed by being struck with the hammer member 11 and the striking portion 25 stops under a state in which the striking portion 25 has been lowered to a height near the placement table 10, the confirmation sensor 17 detects the detection piece 83 of the dog 80. Meanwhile, when the crushing is insufficient and the striking portion 25 stops under a state in which the striking portion 25 has been raised significantly above the placement table 10, the confirmation sensor 17 may not detect the detection piece 83 of the dog 80. Thus, the confirmation sensor 17 is in an OFF state when the height of the hammer member 11 after striking the drug packaging bag 100 is high, and is in an ON state when the height of the hammer member 11 after striking the drug packaging bag 100 is low.

### (Base)

The base 2 includes a metal plate 85, which is quadrangular in plan view, and four leg portions 86. Heights of the leg portions 86 are not the same, and the metal plate 85 of the base 2 is inclined. In one or more embodiments, as illustrated in FIG. 2, a height of the hammer member 11 on a proximal side is lower than that on the placement table 10 side. With the posture of the entire drug crushing device 1 according to one or more embodiments being inclined, the entire drug crushing device 1 is prevented from moving due to an impact applied when the hammer member 11 is swung down.

### (Details)

As may be understood through comparison between FIG. 1A and FIG. 1B, and FIG. 4A, a guide cover 87 is provided on the introduction side of the drug crushing device 1 according to one or more embodiments and over the geared motor 60 of the power transmission mechanism 61 of the feeder 6. The guide cover 87 has an arc shape, and its upper end side reaches the vicinity of the placement table 10.

On a side surface of the placement table 10 and on the introduction side, a guide wall 88 is provided as illustrated in FIG. 1A, FIG. 1B, FIG. 12A, and FIG. 12B. An end portion of the guide wall 88 is widened so as to easily accept a drug packaging strip 107.

### (Drug Packaging Bag)

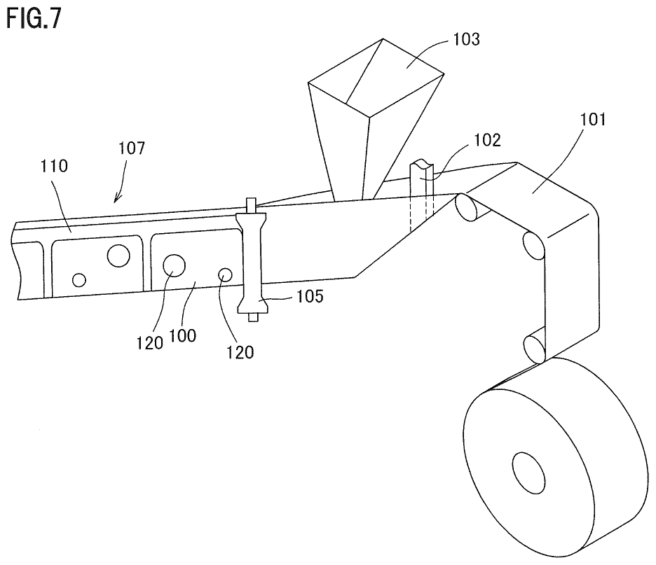

As described above, the drug crushing device 1 according to one or more embodiments is a device that allows the drug packaging bags 100 connected to each other in a strip shape to be put thereon, crushes the drugs by striking the tablets 120 (drugs) contained in the drug packaging bags 100 with the hammer member 11, and feeds the drug packaging bags 100 subjected to crushing, to the outside. Next, the drug packaging bag 100 is described. The drug packaging bag 100 is made by folding a drug packaging paper sheet 101 in two, loading the tablets 120 into the folded sheet, and thermally fusing three sides of the folded sheet surrounding the tablets to form a bag. Specifically, as illustrated in FIG. 7, the drug packaging paper sheet 101 in a roll shape is fed, and the drug packaging paper sheet 101 is folded at a triangular plate 102. Then, tablets are loaded into the drug packaging paper sheet 101 from a hopper 103 while the drug packaging paper sheet 101 is being folded. A sealing device 105 then fuses and seals a region around a portion into which the tablets 120 have been loaded. After passing through the sealing device 105, the drug packaging bags 100 are connected to each other in a strip shape. Perforations (not shown) are formed between adjacent drug packaging bags 100. Along one edge of a strip shape of the drug packaging strip 107, which is obtained by connecting the drug packaging bags 100 to each other in a strip shape, has a joining edge 110 at which the drug packaging paper sheet 101 is joined.

### (Operation)

Next, operation of the drug crushing device 1 is described. As illustrated in FIG. 8A, the drug crushing device 1 before use has no drug packaging bag 100, and the hammer member 11 has been lowered. From this state, as illustrated in FIG. 8B, the hammer member 11 is manually raised. The cam mechanism 30 adopted in one or more embodiments has only a function of merely raising the hammer member 11, and hence the cam mechanism 30 is not an obstacle to manually raising the hammer member 11.

Then, one end of the drug packaging strip 107 is put on the introduction side of the placement table 10. Here, as illustrated in FIG. 5, the drug packaging strip 107 is directed such that the joining edge 110 is on the drive-side belt mechanism 15 side and the folded side is inserted in the groove-shaped portion 73 of the guide portion 47. The drive-side belt mechanism 15 is then driven. As a result, the drug packaging strip 107 is sandwiched between the feed belt 56 and the pressing-side roller 16a, and advances toward the discharge side in accordance with the travel of the feed belt 56. When the first drug packaging bag 100 is introduced onto the placement table 10 and a part of the drug packaging bag 100 reaches a position of the opening 22 of the placement table 10, the photoelectric sensor (not shown) in the opening 22 detects the drug packaging bag 100, and the feed belt 56 stops. Through this operation, as illustrated in FIG. 8C, the drug packaging bag 100 at a leading end of the drug packaging strip 107 is placed on the placement table 10. At the time when the first drug packaging bag 100 is introduced onto the placement table 10, the subsequent portion of the drug packaging strip 107 slides and advances smoothly over the guide cover 87.

After that, as illustrated in FIG. 8D, the hammer member 11 is manually returned to its original posture, and the cam followers 28 are brought into contact with the cams 31a and 31b. Then, an automatic switch (not shown) is pressed. As a result, the following steps are automatically executed by a control device (not shown).

### (First Strike)

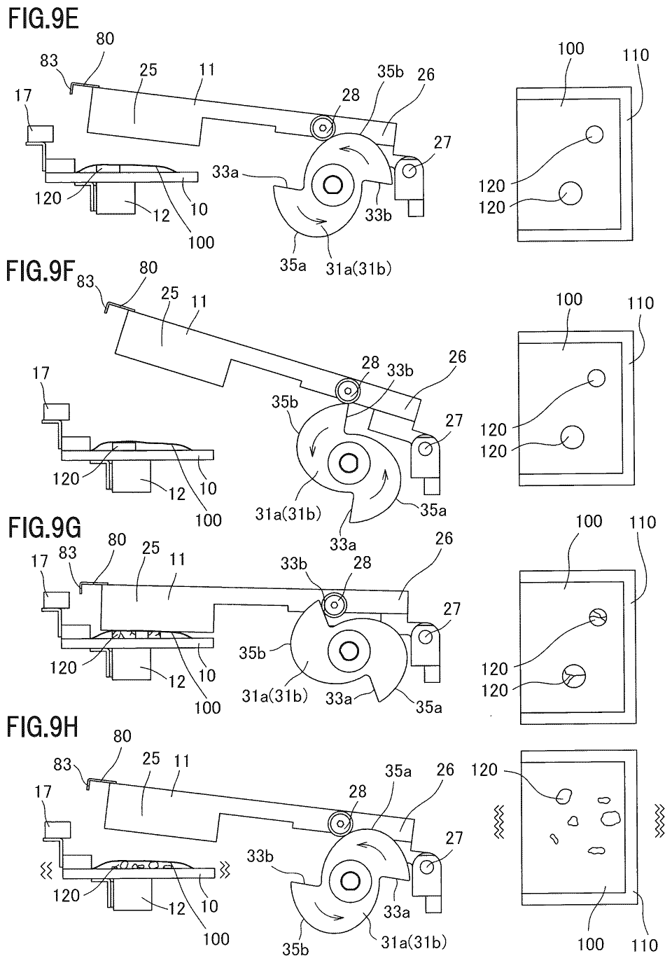

When the motor 37 starts, as illustrated in FIG. 9E, the cams 31a and 31b are rotated, the cam followers 28 rise along the curves 35b of the cams 31a and 31b, and hence the striking portion 25 is raised gradually. When the rotation of the cams 31a and 31b proceeds, as illustrated in FIG. 9F, the cam followers 28 reach boundaries between the curves 35b and the steps 33b of the cams 31a and 31b, and hence the height of the striking portion 25 reaches its highest point. When the rotation of the cams 31a and 31b further proceeds, as illustrated in FIG. 9G, the cam followers 28 reach the steps 33b of the cams 31a and 31b, and hence the cam followers 28 lose support at once. As a result, gravity causes the hammer member 11 to swing downward, and hence the striking portion 25 drops and strikes the drug packaging bag 100 on the placement table 10. As a result, as illustrated in the right part of FIG. 9G, the tablets 120 are cracked. However, fragments are in a lump. Accordingly, the fragments have large sizes, and the hammer member 11 after striking the drug packaging bag 100 is on the fragments. Thus, as illustrated in FIG. 9G, the striking portion 25 stops at a high position. Accordingly, the confirmation sensor 17 may not detect the detection piece 83 of the dog 80 mounted to the striking portion 25.

### (Second Strike and First Vibration)

When the motor 37 starts in the same manner as in the first strike, as illustrated in FIG. 9H, the cams 31a and 31b are rotated, the cam followers 28 rise along the curves 35a of the cams 31a and 31b, and hence the striking portion 25 is raised gradually. In parallel therewith, the vibrator 12 starts, and the placement table 10 vibrates. As a result, the tablets 120 vibrate, and hence the fragments are scattered as illustrated in the right part of FIG. 9H. The posture of the entire drug crushing device 1 according to one or more embodiments is inclined, and the placement table 10 is also inclined. Accordingly, the vibration of the vibrator 12 tends to scatter the fragments of the tablets 120.

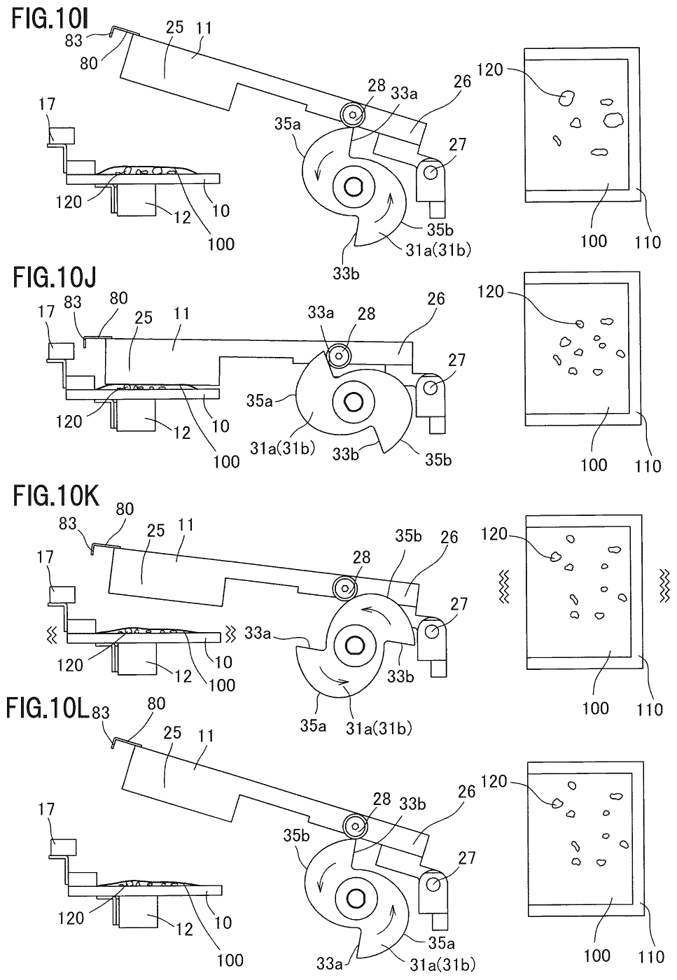

When the rotation of the cams 31a and 31b proceeds, as illustrated in FIG. 10I, the cam followers 28 reach boundaries between the curves 35a and the steps 33a of the cams 31a and 31b, and hence the height of the striking portion 25 reaches its highest point. When the rotation of the cams 31a and 31b further proceeds, as illustrated in FIG. 10J, the cam followers 28 reach the steps 33a of the cams 31a and 31b, and hence the cam followers 28 lose support at once. Thus, the striking portion 25 drops and strikes the drug packaging bag 100 on the placement table 10 again. As a result, as illustrated in the right part of FIG. 10J, the fragments of the tablets 120 become finer. Although the striking portion 25 has reached a position lower than the position after the first strike, the dog 80 does not reach the position of the confirmation sensor 17, and the confirmation sensor 17 may not detect the detection piece 83 of the dog 80.

### (Third Strike and Second Vibration)

When the motor 37 starts in the same manner as in the first strike, as illustrated in FIG. 10K, the cams 31a and 31b are rotated, the cam followers 28 rise along the curves 35b of the cams 31a and 31b, and hence the striking portion 25 is raised gradually. In parallel therewith, as illustrated in FIG. 10K, the vibrator 12 starts, and the placement table 10 vibrates. As a result, the tablets 120 vibrate, and hence the fragments are further scattered.

When the rotation of the cams 31a and 31b proceeds, as illustrated in FIG. 10I, the cam followers 28 reach boundaries between the curves 35b and the steps 33b of the cams 31a and 31b, and hence the height of the striking portion 25 reaches its highest point. When the rotation of the cams 31a and 31b further proceeds, as illustrated in FIG. 11M, the cam followers 28 reach the steps 33b of the cams 31a and 31b, and hence the cam followers 28 lose support at once. Thus, the striking portion 25 drops and strikes the drug packaging bag 100 on the placement table 10 again. As a result, as illustrated in the right part of FIG. 11M, the fragments of the tablets 120 become further finer. The striking portion 25 reaches a position lower than the position after the second strike, and the dog 80 reaches the position of the confirmation sensor 17 as illustrated in FIG. 11M. As a result, the confirmation sensor 17 detects the detection piece 83 of the dog 80.

### (Feeding)

When the confirmation sensor 17 detects the detection piece 83 of the dog 80, the striking is interrupted and a feeding step of discharging the drug packaging bag 100 is carried out. That is, the feeder 6 feeds the drug packaging bag 100 on condition that the crush detector 8 has confirmed that the tablets 120 have been crushed. Specifically, when the confirmation sensor 17 detects the detection piece 83 of the dog 80 and the crush detector 8 confirms that the tablets 120 have been crushed, the motor 37 starts, and the cams 31a and 31b are rotated. Thus, the striking portion 25 is raised, and hence the striking portion 25 is moved away from the drug packaging bag 100. Subsequently, the feeder 6 starts, and the feed belt 56 travels. As a result, the drug packaging bag 100 on the placement table 10 is held by the feed belt 56 and the pressing-side roller 16a, and hence is advanced toward the discharge side in accordance with the travel of the feed belt 56. The feed belt 56 of the drive-side belt mechanism 15 travels by a distance corresponding to a single drug packaging bag 100 and stops automatically. As described above, a plurality of drug packaging bags 100 are connected to each other, and hence the next drug packaging bag 100 is automatically pulled onto the placement table 10. Then, the above-mentioned steps are performed on the next drug packaging bag 100.

Hereafter, this operation is continued automatically. In the above description, the tablets are crushed to a required grain size by three strikes, but the number of times of striking the tablets 120 varies individually. In short, the striking is continued until the confirmation sensor 17 detects the detection piece 83 of the dog 80. Accordingly, the striking may be repeated three or more times. Conversely, after one or two strikes, the striking step may be completed, and the process may proceed to the feeding step. Further, even when the drug packaging strip 107 has drug packaging bags 100 that do not contain any medicine (empty drug packaging bags 100 with prescription data or patient information printed thereon), each drug packaging bag 100 may be struck sequentially. When the drug packaging bag 100 that does not contain any medicine is struck once, the sensor 17 detects the detection piece 83 of the dog 80. Thus, after one strike, the drug packaging strip 107 is conveyed, and striking is performed on the next drug packaging bag 100. As described above, the number of times of striking the tablets 120 is freely selected, but it may be desired that striking be performed a plurality of times. A strong strike is required to crush the tablet 120 into small pieces with a single strike, and there is a fear in that the drug packaging bag 100 may be torn.

### (Relation to Inspection)

Before a drug is handed to a patient, inspection is performed. It may be desired that a drug be crushed after the inspection is completed. The reason therefor is that the tablets 120 have imprints or specific shapes, and when the tablets 120 are crushed, the imprints and the like may not be distinguished. Specifically, the drug packaging bags 100 before crushing are photographed by a camera of an inspection device or visually checked to identify the drugs inside the bags, and thus inspection is performed. After that, the drugs are crushed by the drug crushing device 1.

The crushing unit 5 adopted in the drug crushing device 1 described above includes the striking portion 25 and the handle portion 26 like a hammer, and has the configuration in which the handle portion 26 is supported in a cantilevered manner and raised by cams. However, the scope is not limited to this configuration. For example, a weight-shaped striking portion may be lifted directly above the drug packaging bag by a lifter or the like and then dropped. Alternatively, without relying on gravity, the striking portion may be swung down onto a drug package by an elastic force of a plate spring or a helical spring. A crank or a screw may be used as a mechanism for lifting the striking portion.

In one or more embodiments, the external force applied to the tablets 120 is not limited to an impact force such as a strike, but may be a static force such as crushing with a roller or a press. However, according to experiments conducted by the inventors, the use of a roller or a press has often caused the drug packaging bag 100 to tear.

In the drug crushing device 1 according to one or more embodiments described above, an area of a striking surface of the striking portion 25 is substantially equal to that of the drug packaging bag 100, and the entire drug packaging bag 100 is struck by the striking portion 25. However, the striking portion 25 may be made smaller and configured to perform striking with aim at the tablets 120. For example, the drug packaging bag 100 is photographed to confirm locations of the tablets, and only the tablets 120 are struck. The drug crushing device may also selectively use a plurality of hammer members having different shapes. For example, a hammer member with a circular distal end or a hammer member with a flat distal end is used to crush the tablets 120 depending on a broken state of the tablets 120 and shapes of the tablets 120. The drug crushing device may also alternately use hammer members having different shapes to perform striking, or may automatically select a hammer member having an appropriate shape.

In a case of adopting a configuration in which a roller is used to break tablets, the roller may be simply circular or may have an uneven surface. A roller may be arranged on a board, and the drug packaging bag 100 may be sandwiched between the board and the roller to break the tablets 120 inside the bag. Alternatively, the drug packaging bag 100 may be sandwiched between two rollers to break the tablets 120 inside the bag. In this case, each of the rollers may have an oval sectional shape. Further, in a case of adopting a configuration in which the tablets are broken by rollers, it is desired to arrange the rollers so that the tablets may be crushed a plurality of times.

In the drug crushing device 1 described above, the placement table 10 is vibrated by the vibrator 12 to vibrate the placement table 10, and this vibration vibrates the drug packaging bag 100. However, the placement table 10 may be vibrated through use of measures other than a vibrator. For example, the placement table 10 may be struck with a knocker or the like to vibrate the placement table 10. Alternatively, the drug packaging bag 100 may be vibrated directly.

It may be desired that the timing for vibrating the drug packaging bag 100 be after the crushing operation is performed by the crushing unit 5, but the tablets may be struck while the drug packaging bag 100 is being vibrated.

The feeder 6 adopted in one or more embodiments moves the drug packaging bag 100 by holding only one edge of the drug packaging bag 100. In one or more embodiments, the feeder 6 feeds the drug packaging strip 107 by holding the joining edge 110 of the drug packaging strip 107. The joining edge 110 of the drug packaging strip 107 has such an advantage that the feeder is less liable to jam because the joining edge 110 is a portion having no tablets and having a constant thickness. However, the scope is not limited to this configuration, and the drug packaging strip 107 may be moved by holding another edge or both edges.

The mechanism for feeding the drug packaging bag 100 is not limited to one or more embodiments, but may utilize a conveyor, a roller, or the like.

The size of the drug packaging bag 100 is not fixed, and various sizes are available. Accordingly, it may be desired that an amount of feed of the feeder 6 may be set in accordance with a size of the drug packaging bag 100 to be subjected to crushing. When the amount of feed of the feeder 6 is fixed and may not be changed, it is recommended that the amount of feed be set in conformity with the smallest bag to be used, or be set smaller. When the amount of feed of the feeder 6 is smaller than the drug packaging bag 100 to be actually used, the drug packaging bag 100 subjected to striking may not be fed in one feed. However, the drug packaging bag 100 is merely subjected to more strikes, and no significant harm occurs.

For the same reason, it is also recommended that the drug packaging bag be fed only by an amount corresponding to a length of the striking portion 25 (actually, a length slightly shorter than the length of the striking portion 25). Conversely, when the amount of feed of the feeder 6 is larger than the drug packaging bag 100 to be actually used, or larger than the amount corresponding to the length of the striking portion 25, some tablets 120 may be discharged without being struck, which is not preferred. There are perforations (not shown) between adjacent drug packaging bags 100, and hence the perforations may be detected by a sensor and the feeder 6 may be started and stopped with reference to the perforations. For example, it is conceivable that the drug packaging bag 100 is fed until the perforations are detected.

In one or more embodiments described above, the photoelectric sensor is used as the confirmation sensor 17, but the structure of the confirmation sensor is freely selected. For example, a proximity sensor may be used. Alternatively, a contact type sensor such as a limit switch may be used. A mounting position of the confirmation sensor and a mounting position of the dog are freely selected. In one or more embodiments described above, a cracked state of the tablet is detected from the height of the hammer member 11, but the tablet grain shape may be detected by, for example, an image.

It may be desired that the drug crushing device 1 includes a sensor that detects whether or not the drug contained in the drug packaging bag 100 is a drug that is required to be crushed. When the drug in the drug packaging bag 100 having arrived at the placement table 10 is a drug that is required to be crushed, striking is performed. When the drug in the drug packaging bag 100 having arrived at the placement table 10 is not a drug that is required to be crushed, the bag is fed out by the feeder 6 without performing striking.

In the explanatory view illustrated in FIG. 7, only the tablets 120 are loaded from the hopper 103 into the folded packaging paper sheet 101, but some drug packaging devices may also package powder medicine. In the drug packaging devices of this type, powder medicine and tablets are loaded into the same drug packaging bag 100. However, it may be desired that tablets that are expected to be broken be loaded into the drug packaging bag 100 different from the drug packaging bag 100 for powder medicine. Further, in order to facilitate the use of the drug crushing device 1, it may be desired that the drug packaging bags 100 containing the tablets 120 that are expected to be broken be continuously discharged from the drug packaging device. That is, some drug packaging devices discharge the drug packaging bags in the order of the time of dose, and sometimes discharge the drug packaging bag 100 containing powder medicine subsequently to the drug packaging bag 100 containing the tablet 120. In such cases, it may be desired that the drug packaging bags 100 containing the tablets 120 that are expected to be broken be discharged continuously from the drug packaging device with priority to the ease of breaking the tablets 120 rather than the time of dose.

It may be desired that the drug packaging device may package drugs that are required to be crushed and drugs that are not required to be crushed, in separate bags. It may be desired that the drug packaging device may not only package drugs in the order of the time of dose and generate a drug packaging strip mixedly including drug packaging bags 100 for drugs that are required to be crushed, and drug packaging bags 100 for drugs that are not required to be crushed, but also generate a “drug packaging strip 107A” in which drug packaging bags 100 containing only drugs that are required to be crushed are connected together, and a “drug packaging strip 107B” in which drug packaging bags 100 containing only drugs that are not required to be crushed are connected together. In this way, even when the drug crushing device 1 does not have a function of not executing crushing when the drug crushing device 1 detects the drug packaging bag 100 containing a drug that is not required to be crushed in the drug packaging strip, it is possible to prevent the drug that is not required to be crushed from being crushed when only the “drug packaging strip 107A” is passed through the drug crushing device 1.

In addition, the “drug packaging strip 107A” may include drug packaging bags 100 for drugs that are required to be crushed and are specified in a plurality of pieces of prescription data, instead of one piece of prescription data. In this way, when the “drug packaging strip 107A” is passed through the drug crushing device 1 only once, it is possible to crush drugs that are required to be crushed and are specified in a plurality of pieces of prescription data.

According to one or more embodiments described above, a drug crushing device that crushes a solid drug contained in a bag is provided. The drug crushing device includes: a crushing unit that crushes the drug by applying an external force to the drug contained in the bag; and vibrator, and the bag is vibrated by the vibrator at least after crushing operation is performed by the crushing unit.

The crushing unit includes a placement table on which the bag is to be placed, and a hammer portion, and the hammer portion is swung down onto the bag to crush the drug under a state in which the bag is placed on the placement table. It may be desired that the placement table be vibrated by the vibrator.

The crushing unit includes a placement table on which the bag is to be placed, and a hammer portion, and the hammer portion is swung down onto the bag to crush the drug under a state in which the bag is placed on the placement table. It may be desired that crushing operation of swinging down the hammer portion onto the drug be performed on a single bag a plurality of times, thereby crushing the drug.

The crushing unit includes a placement table on which the bag is to be placed, and a hammer portion, and the hammer portion is swung down onto the bag to crush the drug under a state in which the bag is placed on the placement table. The hammer portion includes a striking portion and a handle portion, and the handle portion is supported in a cantilevered and swingable manner. It may be desired that the striking portion be raised by swinging the handle portion, and that the striking portion be naturally dropped and swung down onto the bag to crush the drug.

According to one or more embodiments described above, a drug crushing device that crushes a solid drug contained in a bag is provided. The drug crushing device includes: a crushing unit that crushes the drug by applying an external force to the drug contained in the bag; and a crush detector that detects whether or not the drug has been crushed. The crushing unit includes a hammer portion, and the hammer portion is swung down onto the bag to crush the drug. The crush detector detects a height of the hammer portion in a state of having been swung down onto the drug.

1. A drug crushing device that crushes a drug contained in a bag, comprising:
a crushing unit that crushes a drug contained in the bag by applying an external force to the drug; and
a crush detector that detects if the drug is crushed, wherein
the bag is moved relative to the crushing unit in response to detecting drug crushing by the crushing detector.

2. The drug crushing device according to claim 1, further comprising a feeder that feeds the bag, wherein
the feeder feeds the bag in response to detecting drug crushing by the crushing detector.

3. The drug crushing device according to claim 1, wherein
the crushing unit comprises a hammer portion that strikes against the bag to crush the drug, and
the crush detector detects a position of the hammer portion that strikes against the drug.

4. The drug crushing device according to claim 2, wherein
the bag comprises a drug packaging paper sheet, a plurality of bags are connected to each other in a strip shape, and one edge of the strip shape has a joining edge at which the drug packaging paper sheet is joined, and
the feeder moves the bags connected to each other in a strip shape by holding the joining edge.

5. The drug crushing device according to claim 1, further comprising a vibrator that vibrates the bag at least after crushing operation is performed by the crushing unit.

6. The drug crushing device according to claim 2, further comprising a vibrator that vibrates the bag at least after crushing operation is performed by the crushing unit.

7. The drug crushing device according to claim 3, further comprising a vibrator that vibrates the bag at least after crushing operation is performed by the crushing unit.

8. The drug crushing device according to claim 4, further comprising a vibrator that vibrates the bag at least after crushing operation is performed by the crushing unit.
